(19) United States
(12) Patent Application Publication
(10) Pub. No.: US 2022/0215739 A1
(43) Pub. Date: Jul. 7, 2022

(54) CHILD ALERT NOTIFICATION SYSTEM

(71) Applicant: Elizabeth Delvalle-Urena, St. Cloud, FL (US)

(72) Inventor: Elizabeth Delvalle-Urena, St. Cloud, FL (US)

(21) Appl. No.: 16/805,877

(22) Filed: Mar. 2, 2020

(51) Int. Cl. G08B 21/24; B60N 2/00; B60Q 5/00; G08B 21/02; G08B 3/10

(52) U.S. Cl. CPC G08B 21/24; B60N 2/002; B60N 2/26; G08B 21/0275; G08B 3/10; B60Q 5/005

(57) ABSTRACT

A child alert notification system including a seat occupancy placement member, a reaction surface member, a plurality of environment sensors, and a control unit. The seat occupancy placement member receives a seat occupant in a vehicle. The reaction surface member is integrated beneath the seat occupancy placement member and includes a plurality of pressure detectors for measuring a seat occupant's loading force on the seat occupancy placement member by measuring pressure applied to the pressure detectors. The plurality of environment sensors sense one or more environment conditions and send one or more notifications to a control unit.

### FIELD OF THE INVENTION

Embodiments described herein generally relate to child alert systems, and more particularly to a child alert notification system.

### BACKGROUND OF THE INVENTION

The National Safety Council reports that child deaths from being left in cars are rising. So many caregivers are overwhelmed with life and are unknowingly forgetting the children in the car. This results in increased death and/or injury of children who may be left unattended in a vehicle. Hence, an efficient notification system for alerting caregivers that a child may be left unattended in a vehicle is desirable.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a child alert notification system according to an embodiment of the present disclosure.

### SUMMARY OF THE INVENTION

Exemplary embodiments disclosed herein describe a child alert notification system including a seat occupancy placement member, a reaction surface member, a plurality of environment sensors, and a control unit. The seat occupancy placement member receives a seat occupant in a vehicle. The reaction surface member is integrated beneath the seat occupancy placement member. The reaction surface member includes a plurality of pressure detectors for measuring a seat occupant's loading force on the seat occupancy placement member by measuring pressure applied to the pressure detectors. The plurality of environment sensors sense one or more environment conditions and send one or more notifications to a control unit. The control unit determines that an occupied child car seat is occupying the seat occupancy placement member of the vehicle, and activates an audio sequence from the vehicle's horn upon detecting that the occupied child car seat remains in the seat occupancy placement member after receiving one or more notifications from one or more of the plurality of environment sensors that the vehicle's engine is turned off and a driver's side door has been shut subsequent to the ignition being turned off.

### DETAILED DESCRIPTION

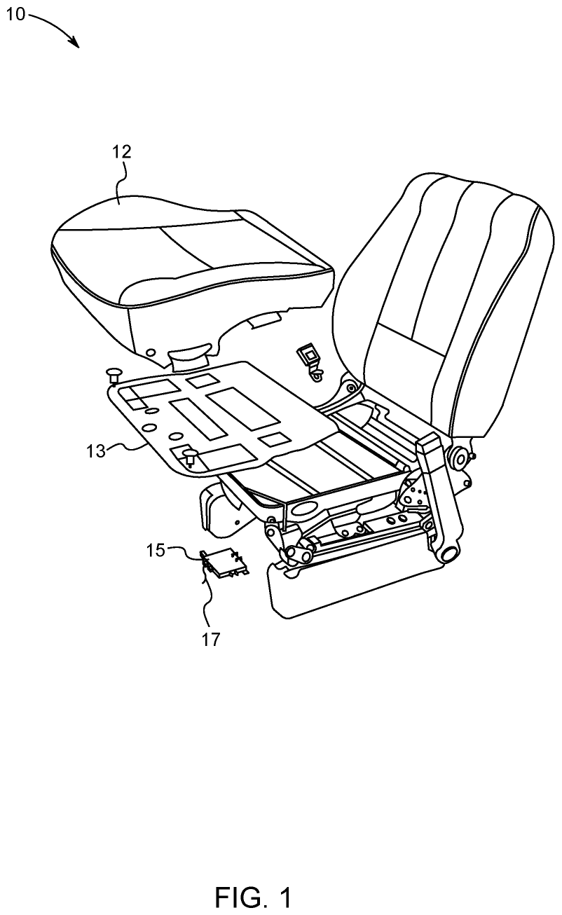

The present disclosure relates to a child alert system (“the system”). The system 10 sets off an alarm notification to alert caretakers that a child remains in the vehicle. As illustrated in FIG. 1, the system 10 includes a seat occupancy placement member 12, a reaction surface member 13, a control unit 15 and a wiring harness/connection 17 which connects to a vehicle's engine control unit. The seat occupancy placement member may include a top surface of a vehicle seat. The seat occupancy placement member is the area of the vehicle where an occupant sits or is positioned. An occupant may include an individual-passenger or an occupied child car seat.

The reaction surface member 13 may be integrated in a vehicle seat directly beneath the seat occupancy placement member 12. The reaction surface member 13 is connected to the vehicle's battery source to draw power for its operation. The reaction surface member may operate to detect that an occupant is occupying the seat occupancy placement member. More specifically, the reaction surface member 13 may detect that a child is occupying a child car seat that is currently occupying the seat occupancy placement member. The reaction surface member may detect the child's occupancy in the child car seat based on weight, or more specifically, a pressure, load, or other force, applied to the seat occupancy placement member 12.

The reaction surface member 13 may be part of a pad, mat, cushion, or related material for positioning on a vehicle seat or for integration within the vehicle seat, such as, for example, a weight pressure sensor pad or other fabric pressure sensor. The reaction surface member may include any substantially flat configuration that detects when a force such as weight or pressure is applied to a surface of the seat occupancy placement member 12 and outputs a signal to the control unit 15 that may be used to trigger an alarm.

In one aspect, the reaction surface member 13 may include an enclosure formed of a thin, flexible durable material inside which includes a pressure sensor. The pressure sensor may consist of a plurality of individual pressure detectors which are interconnected in an array so as to provide a pressure pattern acting on at least the relevant parts of the seating occupancy placement member 12. The interconnected array of pressure detectors integrated in the enclosure forms the reaction surface member's pad or mat which is integrated in the vehicle seat. The pressure sensor detects a pressure profile generated by an occupant in the seat occupancy placement member, such as, for example, an individual-occupant, an unoccupied child car seat-occupant, or an occupied child car seat-occupant. In order to detect the pressure profile on the seating surface of a vehicle seat, the pressure sensor is preferably arranged in a suitable location of the seating portion of the seat. The control unit 15 can estimate the weight of the occupant with the data provided by the pressure sensor.

In another aspect, the reaction surface member 13 may include one or more force sensors, load sensors, or the like which measure a force, for example, a weight, applied to the seat occupancy placement member 12 within their range. So, for example, the force or load sensors may be configured to sense a weight greater than a predetermined baseline threshold. When the sensors (i.e., load sensors or force sensors) detect that the weight load in the vehicle's seat exceeds a predetermined baseline threshold, the reaction surface member sends a signal to the control unit 15 to provide notification of an alarm trigger event. Thereafter, the control unit 15 sends a signal to activate an audio sequence by the vehicle's horn.

The control unit 15 may be integrated in the vehicle seat and may be connected to the vehicle engine control unit (ECU). The control unit may be configured as a printed circuit board (PCB) or an integrated circuit (IC). The control unit may include a microprocessor and a memory. The memory includes microprocessor executable instructions which cause the microprocessor to detect the presence of a child car seat in a vehicle, to establish one or more baseline values for the detected child car seat, to determine whether a child is occupying the detected child car seat, to determine whether the child is occupying the detected child car seat after a safety hazard event occurs, and to activate an audio sequence from the vehicle's horn upon detecting that the child is occupying the detected child car seat after the safety hazard event occurred.

The control unit 15 includes a detector for detecting the presence of a child car seat in at least one of a vehicle seat. The detector may include a RFID reader which reads a RFID tag which may be incorporated in a child car seat. When the child car seat gets within a certain proximity of the RFID reader, the RFID reader will read the RFID tag integrated in the child car seat and determine that a child car seat is present in at least one vehicle seat.

After the child car seat is detected for the first time, the control unit 15 initiates a calibration process. The calibration process directs a user to situate the child car seat in different ways (forward facing, rearward facing, empty, with a small item, etc.) on a vehicle seat to gather various weight measurements of the child car seat from the reaction surface member 13. The control unit establishes a baseline threshold and/or a baseline threshold range from the various weight measurements, for example, by taking the average of the weight measurements. The baseline threshold or the baseline threshold range corresponds to an unoccupied child car seat condition. The control unit 15 may use the baseline values to make occupancy determinations.

When the control unit 15 receives weight or pressure data from the reaction surface member 13, the control unit can determine whether a child is occupying the detected child car seat by evaluating the weight measurement with the baseline threshold or the baseline threshold range. If the measured weight by the reaction surface member 13 exceeds the baseline threshold or the baseline threshold range, then the control unit 15 may determine that a child is occupying the car seat.

The system 10 includes a plurality of environment sensors, such as, for example, an ignition sensor and a door sensor. The ignition sensor is installed where the ignition is located and the sensor operates to send a signal (i.e., ignition notification) to the control unit 15 when an ignition off event occurs. The door sensor may be installed in any of the vehicle doors, such as, for example, the driver side door. The door sensor operates to send a signal (i.e., door notification) to the control unit 15 when a door shut event occurs. The control unit 15 determines whether a door notification occurred after the occurrence of the ignition notification based on the timing of receipt for each notification. When the door notification occurs after the ignition notification, the control unit 15 concludes that the driver or caregiver has left the vehicle.

When the control unit 15 determines that the door notification occurred after the ignition notification, the control unit 15 requests a weight measurement (i.e., loading force) from the reaction surface member 13 to determine if a child is still present in the vehicle. As noted, the control unit can make the determination of whether a child is still present in the child car seat by evaluating the weight measurement with the baseline threshold or the baseline threshold range. If the child is determined to still be in the child car seat in the vehicle, then the control unit 15 initiates an alarm signal to the vehicle's horn system. The alarm signal causes the horn to output a unique alarm sound. The unique alarm sound may include a beep sound at an interval of two honks per two-three seconds. The alarm sound repeats continuously until the weight measurement from the reaction surface member 13 equals or is less than the baseline threshold or the baseline threshold range, which is an indication that the child has been removed from the car seat or that the child and the child car seat has been removed from the vehicle.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A child alert notification system comprising:
a seat occupancy placement member for receiving a seat occupant in a vehicle;
a reaction surface member integrated beneath the seat occupancy placement member, the reaction surface member including a plurality of pressure detectors for measuring a seat occupant's loading force on the seat occupancy placement member by measuring pressure applied to the pressure detectors;
a plurality of environment sensors for sensing one or more environment conditions and for sending one or more notifications to a control unit; and
the control unit for determining that an occupied child car seat is occupying the seat occupancy placement member of the vehicle, and activating an audio sequence from the vehicle's horn upon detecting that the occupied child car seat remains in the seat occupancy placement member after receiving one or more notifications from one or more of the plurality of environment sensors that the vehicle's engine is turned off and a driver's side door has been shut subsequent to the ignition being turned off;
wherein the control unit initiates a calibration process to gather various weight measurements of a child car seat from the reaction surface member upon detection of the child car seat for a first time;
wherein the reaction surface member includes an enclosure formed of a thin flexible durable material including a pressure sensor for detecting a pressure profile;
wherein the pressure sensor includes a plurality of individual pressure detectors that are interconnected in an array in the enclosure and are arranged in a suitable location so as to provide a pressure pattern acting on at least one or more relevant parts of the seating occupancy placement member.

2. The system of claim 1, wherein the control unit detects the presence of a child car seat in the seat occupancy placement member.

3. The system of claim 2, wherein the control unit includes a RFID reader for detecting the presence of the child car seat in the seat occupancy placement member.

4. The system of claim 1, wherein the control unit determines a baseline threshold for an unoccupied child car seat occupying the seat occupancy placement member.

5. The system of claim 1, wherein the control unit determines a baseline threshold range for an unoccupied child car seat occupying the seat occupancy placement member.

6. The system of claim 4, wherein the control unit determines whether a detected child car seat occupying the seat occupancy placement member is occupied by a child based on the measured seat occupant's loading force on the seat occupancy placement member and the baseline threshold of an unoccupied child car seat occupying the seat occupancy placement member.

7. The system of claim 5, wherein the control unit determines whether a detected child car seat occupying the seat occupancy placement member is occupied by a child based on the measured seat occupant's loading force on the seat occupancy placement member and the baseline threshold range of an unoccupied child car seat occupying the seat occupancy placement member.

8. The system of claim 1, wherein the audio sequence may include a beep sound at an interval of two honks per two-three seconds.

9. The system of claim 8, wherein the audio sequence repeats continuously until a weight measurement from the reaction surface member equals or is less than a baseline threshold or a baseline threshold range.
